(19) United States
(12) Patent Application Publication
(10) Pub. No.: US 2022/0287266 A1
(43) Pub. Date: Sep. 15, 2022

(54) Side-Gate Assembly for Needling Access in a Livestock Squeeze Chute

(71) Applicant: Northquip Inc., Woodlands (CA)

(72) Inventors: Philip Malcolm Firth, Woodlands (CA); Stephen Arthur Langrell, Woodlands (CA)

(21) Appl. No.: 17/627,473

(22) PCT Filed: Nov. 29, 2019
(86) PCT No.: PCT/CA2019/051708

§ 371 Date: Jan. 14, 2022

Related U.S. Application Data
(60) Provisional application No. 62/929,188, filed on Nov. 1, 2019.

(51) Int. Cl. A01K 1/00

(52) U.S. Cl. CPC A01K 1/0029

(57) ABSTRACT

A livestock squeeze chute features a side-gate frame delimiting a side-access opening for lateral access to an animal secured in the chute's head gate. An openable/closeable side-gate is movably coupled to the gate frame to enable selective obstruction of a lower area of the side-access opening. An upper barrier is movably coupled to the side-gate for movement into and out of a closed state at least partially obstructing an upper area of said side-access opening. A hinged connection by which said side-gate is both pivotably and removably coupled to said gate frame comprises a set of male stub shafts and a cooperating set of female receptacles, by which said side-gate is pivotally movable at a first elevation, and fully removable when lifted to a greater second elevation. When both are removed from the frame, the barrier is set an angle forming a supportive prop for the gate.

### FIELD OF THE INVENTION

The present invention relates generally to livestock handling equipment, and more particularly to a squeeze chute having a side-access needling gate next to the head gate to access an animal's neck area for syringe-based treatment (“needling”) or other inspection or treatment of the animal.

### BACKGROUND

In the field of livestock handling equipment, it is known to equip a squeeze chute with needling access by which one can see and reach the neck of an animal secured in the head gate of the chute at the exit opening thereof from which the animal subsequently departs the chute once released from the head gate.

Applicant's commercialized Q-Catch 86 Series Squeeze Chute is one such example, in which each side of the chute features a cladded lower panel removably mounted in the lower half of a framed side-access opening situated between the chute exit and the respective movable side panel of the chute. This cladded lower panel is accompanied by a removable barrier bar, that when installed, spans the top half of the side access opening from the top of the cladded lower panel to the top of the side-access frame. If upper access to the animal's neck is sufficient, the bar is removed, and the cladded lower panel left in place for kick protection. If full-height access to the animal is required, for example to enable more thorough inspection, then the cladded lower panel is also removed.

Another example is shown in Published U.S. Patent Application US2018/0146639 of the Sioux Steel Company, where instead of a removable cladded panel, a skeletal gate is permanently and pivotally mounted in a framed side-access opening between the side panel and exit of the chute, and normally resides in a closed position, but is selectively openable by way of a foot-operated pedal for hands free operation.

Despite these prior designs, there remains room for improved and alternative solutions for providing needling access in a livestock squeeze chute.

### SUMMARY OF THE INVENTION

According to a first of the invention there is provided, in a livestock squeeze chute comprising a primary structural frame, a pair of movable side-walls situated on laterally opposing sides of an interior space of the squeeze chute through which animals traverse on a longitudinal pathway from an entrance opening at a first end of said squeeze chute to an exit opening at a longitudinally opposing end of said squeeze chute, and a head gate operably installed at said exit opening to enable securement of an animal at said exit opening, a side-gate assembly residing adjacent said exit opening in a space between a border frame of said exit opening and a respective one of the movable side walls, said side-gate assembly comprising:

a side-gate frame delimiting a side-access opening that communicates into the interior space of the squeeze chute from a surrounding environment external thereto for lateral access to an animal secured in the exit opening by the head gate;

an openable/closeable lower side-gate movably coupled to said side-gate frame in movable relation thereto between a closed position obstructing a lower area of said side-access opening, and an open position revealing said lower area of the side-access opening to enable access to the animal through said revealed lower area of the side-access opening; and

an upper barrier movably coupled to the lower side-gate in movable relation to the closed position thereof between a closed state at least partially obstructing an upper area of said side-access opening above the lower side-gate, and an open state withdrawn from said upper area of said side-access opening to enable greater access to the animal through said revealed upper area of the side-access opening.

According to a second aspect of the invention there is provided, in the same type of livestock squeeze chute recited in the preamble of the first aspect of the invention,

a side-gate frame delimiting a side-access opening that communicates into the longitudinal pathway of the squeeze chute from a surrounding environment external thereto for lateral access to an animal secured in the exit opening by the head gate; and

an openable/closeable side-gate movably coupled to said side-gate frame in movable relation thereto between a closed position obstructing at least a substantial portion of said side-access opening, and an open position revealing said substantial portion of said side-access opening to enable access to the animal through said revealed lower area of the side-access opening;

wherein said side-gate is pivotably coupled, and also removably coupled, to said side-gate frame by a hinged connection that comprises a set of male stub shafts and a cooperating set of female receptacles, which are distributed among said side-gate and said gate frame in co-operable relative positions to one another such that said side-gate is pivotally movable between the open and closed positions while at a first elevation relative to the gate frame, and is removable from the gate frame by lifting of the side-gate to a greater second elevation at which the male stub shafts are disengaged from said female receptacles.

According to a third aspect of the invention, there is provided, in the same type of livestock squeeze chute recited in the preamble of the first or second aspect of the invention, a side-gate frame delimiting a side-access opening that communicates into the interior space of the squeeze chute from a surrounding environment external thereto for lateral access to an animal secured in the exit opening by the head gate;

a lower side-gate configured for selective removable placement thereof in a closed position obstructing a lower area of said side-access opening;

an upper barrier configured for selective removable placement thereof in a working position standing upright from the closed position of the lower side-gate to at least partially obstruct an upper area of said side-access opening above said lower side-gate;

wherein the lower side-gate and the upper barrier are further configured for co-operable interaction in a self-supporting condition removed from said gate frame, with the upper barrier angling downward from said side-gate and thereby forming a supportive prop between said side-gate and an underlying support surface.

### BRIEF DESCRIPTION OF THE DRAWINGS

One embodiment of the invention will now be described in conjunction with the accompanying drawings in which:

FIG. 1A a perspective view of a squeeze chute equipped with a pair of needling access side-gate assemblies according to the present invention.

FIG. 1B another perspective view of the squeeze chute of FIG. 1A from an opposing side thereof.

FIG. 2 is a partial perspective view of the squeeze chute of FIG. 1 from the same vantage point as FIG. 1A, but enlarged to better show one of the side-gate assemblies thereof.

FIG. 3 is an isolated perspective view of the side-gate assembly of FIG. 2.

FIG. 4 is an enlarged fragmentary view of the side-gate assembly of FIG. 3, as connected to a front end of a movable side wall of the chute.

FIG. 5A is a perspective view of the same side of the squeeze chute as FIG. 1A, but from a more rearward vantage point and with an enlarged inset view, and shows an upper barrier member of the respective side-gate assembly swung down into an open state hanging from a lower side-gate of the gate assembly.

FIG. 5B is a similar perspective view and enlarged inset to FIG. 5A, but shows the lower side-gate of the gate assembly swung out into an open position with the upper barrier member remaining in its hanging position thereon.

FIG. 5C is a similar perspective view and enlarged inset to FIG. 5B, but shows the lower side gate and hanging upper barrier member having been removed from a gate frame of the squeeze chute on which they are normally supported.

FIG. 6 illustrates the removed gate/barrier combination of FIG. 5C in isolation from the squeeze chute, and in a self-standing position in which the barrier member props up the side gate.

FIG. 7 is a partial cross-sectional view of the side-gate assembly of FIG. 3, as viewed along line A-A thereof.

In the drawings like characters of reference indicate corresponding parts in the different figures.

### DETAILED DESCRIPTION

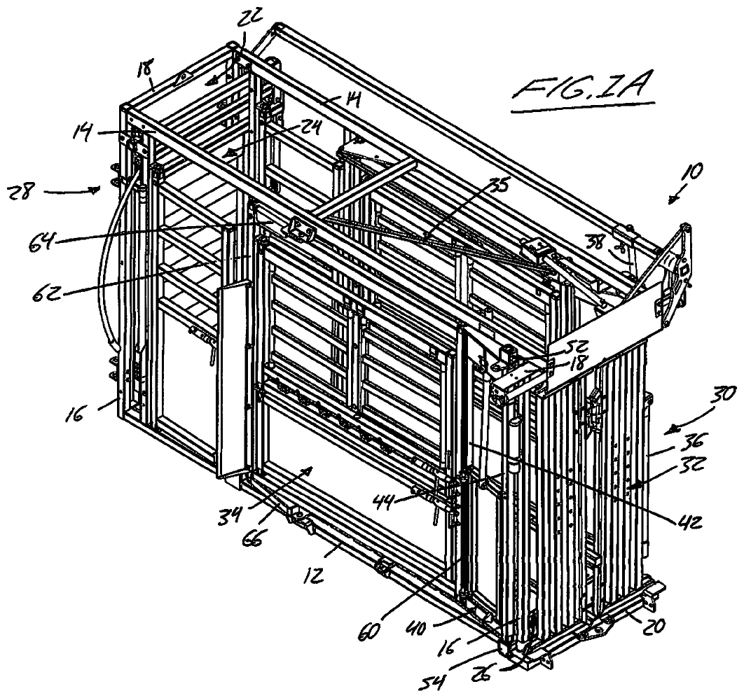

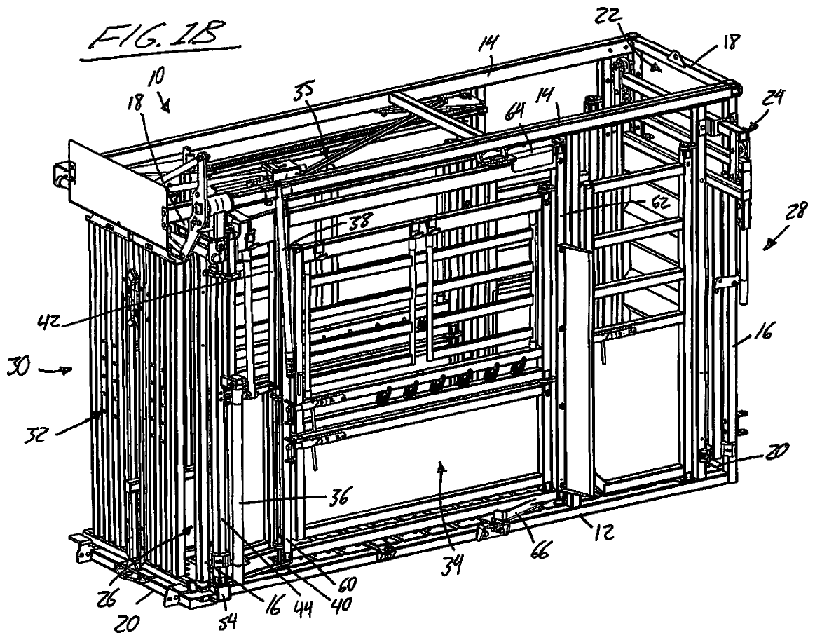

With initial references to FIGS. 1A and 1B, there is shown a livestock squeeze chute according to one embodiment of the present invention. The chute 10 features a primary structural frame on which all other components of the chute are supported. The primary structural frame includes a pair of longitudinal floor beams 12 lying horizontally in a longitudinal direction of the chute, a pair of longitudinal header beams 14 lying horizontally in parallel relation to the floor beams 12 in elevated relation thereover at a top of the chute, and a set of corners posts 16 each standing vertically upright from one of the floor beams 12 at an end thereof to perpendicularly interconnect same to the matching end of one of the longitudinal header beams 14. The two respective corner posts 16 at each end of the chute are perpendicularly connected at their upper and lower ends, respectively, by a pair of horizontal upper and lower cross members 18, 20. The structural frame thus delimits an interior space of generally rectangular volume. At each end of the chute, the two respective corner posts and respective upper and lower cross members collectively denote a border frame around a respective rectangular opening through which entrance and exit to and from said interior space is possible, thereby enabling traversal through said interior space from one opening to the other on a longitudinal pathway therebetween.

The border-framed opening at a first of these two ends of the chute is referred to herein as an entrance opening 22 through animals are admitted into the interior space in controlled one-by-one fashion via a sliding gate 24 installed on the primary structural frame adjacent to this entrance opening 22. The border-framed opening at the opposing second end chute is referred to herein as an exit opening 26 through which animals depart the interior space of the chute once having travelled therethrough on the longitudinal path from the opposing entrance opening. The first and second ends of the chute are thus also referred to as the rear and front ends 28, 30 of the chute, respectively, in relation to the travel direction of animal's moving therethrough, moving forwardly from the rear end of the chute toward the opposing front end thereof. Departure of the individually admitted animal from the chute through the exit opening at the front end thereof is controlled via a head gate 32, closing of which is performed while the animal is initially passing through the exit opening 26 so that opposing sides of the head gate abut against opposing sides of the animal's body to help hold the animal in a position in which their head resides outside the chute, while the trailing remainder of their body is still inside the chute.

To further hold the animal stationary in this position, the chute 10 features a pair of movable side walls 34, each normally residing in a non-working position situated generally within a vertical plane bound by the longitudinal floor beam 12, longitudinal header beam 14, and two corner posts 16 at a respective side of the chute. Via a control linkage 35, for example operable by a squeeze control lever 36 installed externally on one side of the chute near the head gate 32 and exit opening 26, the two side walls 34 are selectively movable in an inward direction toward one another and into the interior space of the squeeze chute in order to constrict the width of the interior space and thereby squeeze against opposing sides of the trailing rear portion of the animal's body inside the chute. This cooperates with the head gate 32 to further constrain the animal in a stationary position for safe inspection and/or treatment thereof by a human operator from laterally outside the chute. While the illustrated example is a manually operated squeeze chute with a squeeze control lever 36, and a likewise manually-operated head gate control lever 38 hanging externally on the same side of the chute, it will be appreciated from the following description that the present invention may be employed on a variety of different squeeze chutes, whether those relying on manual actuation force like the illustrated embodiment, or using powered actuation means, for example hydraulic actuators and appropriate hydraulic circuitry and controls, examples of which are already known in the art.

At a front end of each side wall 34, there is coupled thereto a side-gate frame 40 via a pivotal connection enabling relative pivoting between the side wall 34 and the side-gate frame 40 about a vertically upright pivot axis. The side-gate frame 40 features a rear frame member 42 standing vertically upright, a front frame member 44 standing parallel thereto in horizontally spaced relation therefrom, a bottom cross-member 46 spanning horizontally between the front and rear frame members at bottom ends thereof, and a top cross-member 48 spanning horizontally between the front and rear frame members at top ends thereof in parallel relation to the bottom cross-member 46. These four frame members of the side-gate frame 40 thus delimit a rectangular side-access opening 50 of relatively tall narrow proportions, having a height of notably greater vertical measure between the top and bottom cross-members 48, 46 than a width of the side-access opening 50 measured horizontally between the front and rear frame members 44, 42.

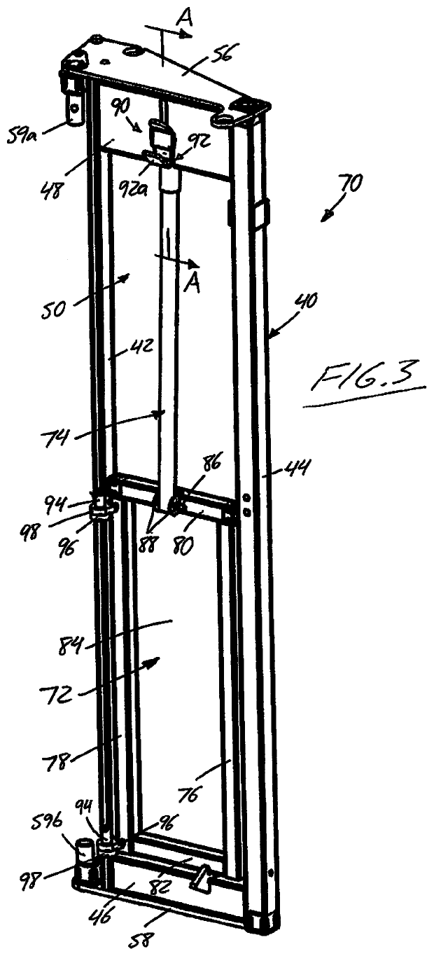

The front frame member 44 is supported on the structural frame of the chute in a hinged fashion, having its top and bottom ends rotatably supported on the structural frame for pivotal movement about another vertical pivot axis, for example via vertically oriented stub axles respectively fitted in top and bottom support blocks 52, 54 mounted to the outside of the longitudinal header and floor beams 14, 12, respectively. These stub axles are mated with respective bushings fitted at top and bottom ends of the front frame member 44 of the gate frame. The gate frame 40 is also coupled to the side wall 34 in hinged fashion, for example via top and bottom support plates 56, 58 that are respectively affixed atop and beneath the top and bottom cross-members 48, 46 of the gate frame, and are pivotally coupled to a front end of the side wall 34. In the illustrated example, the pivotal connection is established by top and bottom vertically oriented stub axles 59a, 59b (FIG. 3) mounted to the support plates 56, 58 at overhanging rear ends thereof situated rearwardly past the rear frame member 42 of the gate frame. These stub axles 59a, 59b are rotatably received in respective bushings fitted at the top and bottom ends of a vertically upright member 60 of the side wall 34 at the front end thereof. The opposing rear end of each side wall 34 is likewise pivotally supported at the top and bottom ends thereof, for example via such vertical stub axles and bushings at top and bottom ends of a vertical rear member 62 of the side wall. The stub axles of these connections are provided on a set of upper and lower swing arms 64, 66 pivotally pinned to the longitudinal header and floor beams 14, 12 at the respective side of the chute so that so that movement of the rear end of the side wall is constrained by these swing arms during movement of the side wall 34 and pivotally attached gate frame 40.

The side wall 34 and the gate frame 40 are thus linked for co-operable movement relative to the primary structural frame of the chute, so that when the squeeze operating lever 36 is raised up into a generally horizontal working position spanning laterally outward from the front frame member 44 of one of the gate frames 40 from a normally stowed position hanging downwardly and externally therebeside, pushing of the squeeze operating lever 36 in a rearward direction causes the gate frame 40 to pivot inwardly of the chute, and the connected side wall 34 to shift laterally inward into the working position. The linkage 35 connected between the gate frame and side wall combination on one side of the chute to the matching gate frame and side wall combination at the opposing side of the chute causes synchronous movement of both combinations from the non-working position to the working position.

Thus far, the forgoing description resembles a known squeeze chute construction closely reflecting that of Applicant's aforementioned Q-catch 86 Series squeeze chute, and is used in a non-limiting manner simply to set the general context of the present invention. The present invention relates more particularly to a novel, inventive design of the overall side-gate assembly co-operably formed by the above described gate frame, and cooperating components to which further attention is now turned. It will be appreciated that this novel gate assembly can be employed in other varieties of squeeze chute similarly having a front head gate and a pair of movable side walls, regardless of the particular construction and operating details thereof.

FIG. 3 shows one of the two the gate assemblies 70 in isolation from the rest of the chute. The other gate assembly includes the same features shown in FIG. 3 and described below, and differs therefrom only in the addition of the squeeze operating lever 36 to the front frame member 44 of the gate frame. In addition to the already described gate frame 40 and the support plates 56, 58 thereof by which the gate assembly is pivotally coupled to the respective movable side wall 34 of the chute, the gate assembly features a swingable lower side-gate 72 removably mounted to a lower half of the gate frame 40 to normally obstruct a lower area of the side access opening 50, and a swingable upper barrier member 74 pivotally coupled to the lower side-gate 72 to normally stand upright therefrom in a position partially obstructing an upper area of the side access opening.

In the illustrated embodiment, the lower side-gate is a cladded gate comprising a rectangular perimeter frame composed of vertically upright front and rear side members 76, 78 lying parallel to the front and rear members 44, 42 of the gate frame 70 in close respective adjacency thereto when the side-gate 72 is in its closed position. The perimeter frame of the side-gate 72 further includes a pair of upper and lower cross-bars 80, 82 perpendicularly joining the front and rear side members 76, 78 at the top and bottom ends thereof, respectively, and a solid cladding panel 84 affixed to the perimeter frame to span the entire area bound thereby. The cladded gate thus forms a solid lower barrier obstructing any potential kicking or mis-step of an animal's leg through the lower half of the side-access opening 50.

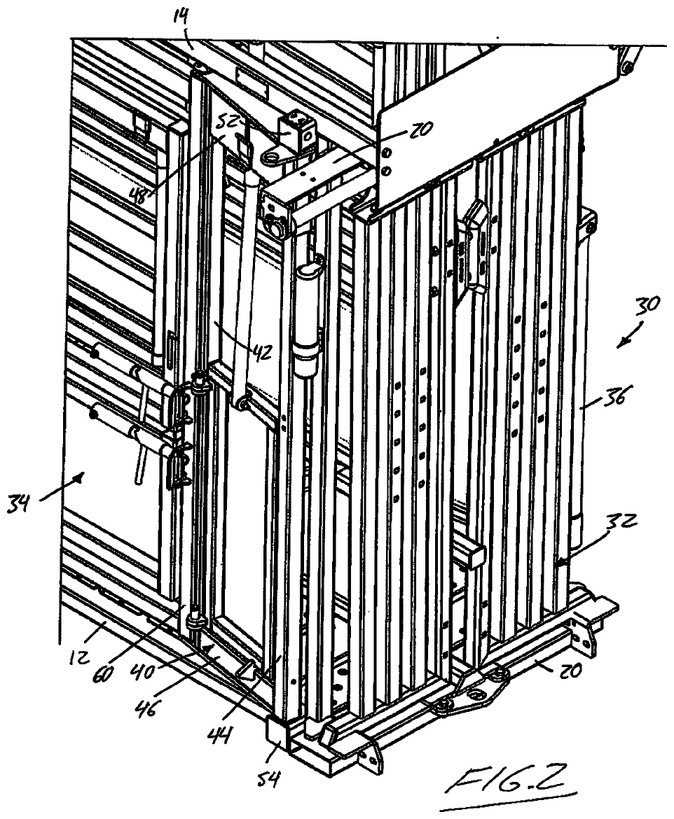

The upper barrier member of the illustrated embodiment is an elongated bar, for example a length of hollow metal tubing, having a notable lesser width than that of the lower side-gate 72. The barrier member 74 has a proximal end pivotally pinned to the lower side-gate 72 via a horizontal pivot pin 86 that penetrates through the barrier member 74 and through a pair of outwardly projecting lugs 88 that are attached to the upper cross-bar 80 near the top end of the gate on opposite sides of the barrier member 74. The barrier member 74 is thus pivotable in a vertical plane into and out of a closed state in which the barrier member 74 stands upright from the top end of the closed lower side-gate 72 and spans upwardly therefrom to the top cross-member 48 of the gate frame 40, thus partially obstructing the upper area of the side-access opening 50, as shown in FIGS. 1 to 4. The barrier member is pivotable from this closed state spanning upwardly across the upper area of the side-access opening, into an open state withdrawn into non-obstructing relation thereto.

The barrier member 74 is normally held in the closed state via a slam latch mechanism 90 installed on the top cross-member 48 of the gate frame 40. The latch mechanism 90 comprises a downwardly-biased catch 92 mounted in vertically slidable fashion on the top cross-member 48 in normally obstructing relation to a receiving cavity that opens into the cross-member 48 at the underside and outer face thereof to accommodate a distal end of the barrier member 74 when closed. The downwardly-biased catch 92 has an obliquely oriented outer working face 92a that angles upwardly and outwardly from the top cross-member 48 so that swinging of the barrier member 74 toward the top cross-member 48 during a closing stroke of the barrier member automatically displaces the catch 92 upwardly out of its normal locking position. This upward shifting of the catch 92 accommodates movement of the distal end of the barrier member 74 into the receiving cavity of the top cross-member 48, upon which the catch 92 is then biased back downwardly into its locking position blocking subsequent withdrawal of the barrier member's top end from the cavity. The downward bias may be defined entirely by gravitational action, or by aid of spring loading mechanism. The barrier member 74 is thus automatically locked in the closed state, until the catch 92 is later manually lifted by a user. This is of course only one non-limiting example of a suitable latching mechanism usable to normally hold the barrier member in the closed state.

The position of the barrier member 74 is generally centered across the width of the lower side-gate 72, and thus is likewise centered across the side-access opening 50, whereby even the partial obstruction of the upper area of the side-access opening 50 by the relatively narrow and centrally positioned barrier member 74 is sufficient to prevent an animal's head from being passed through this upper area during the animal's traversal of the longitudinal pathway through the chute. Accordingly, the animal's natural tendency to seek exit from the chute will lead them instead to the open head gate 32 at the exit opening 26 of the chute. At the same time, the partial degree of obstruction to the upper area of the side-access opening 50 gives a human operator a substantial degree of visual and physical access to the animal via the open space left on both sides of the closed barrier member 74, which in most instances will be ample roof for conventional inspection and treatment of the animal's neck.

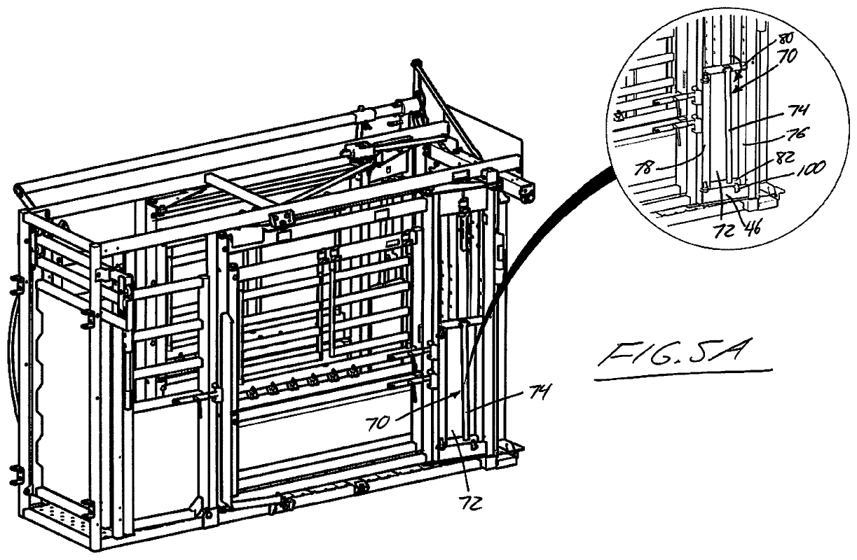

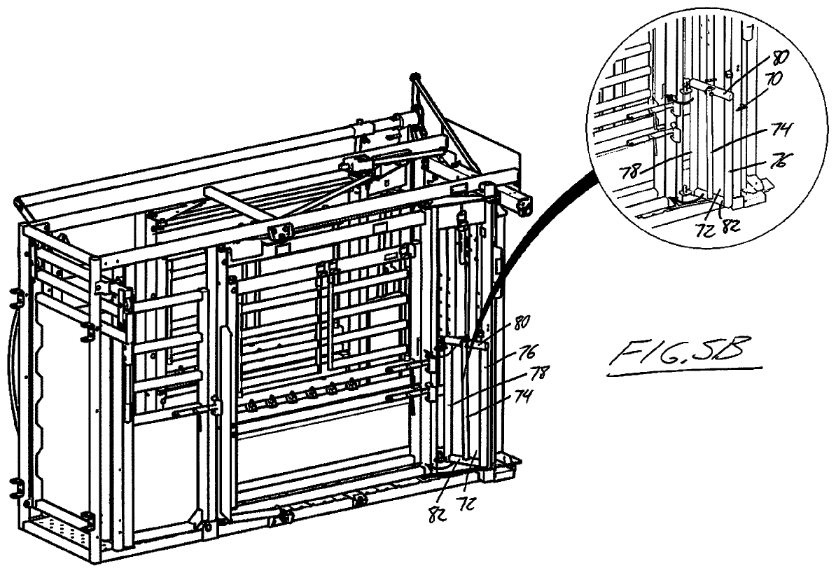

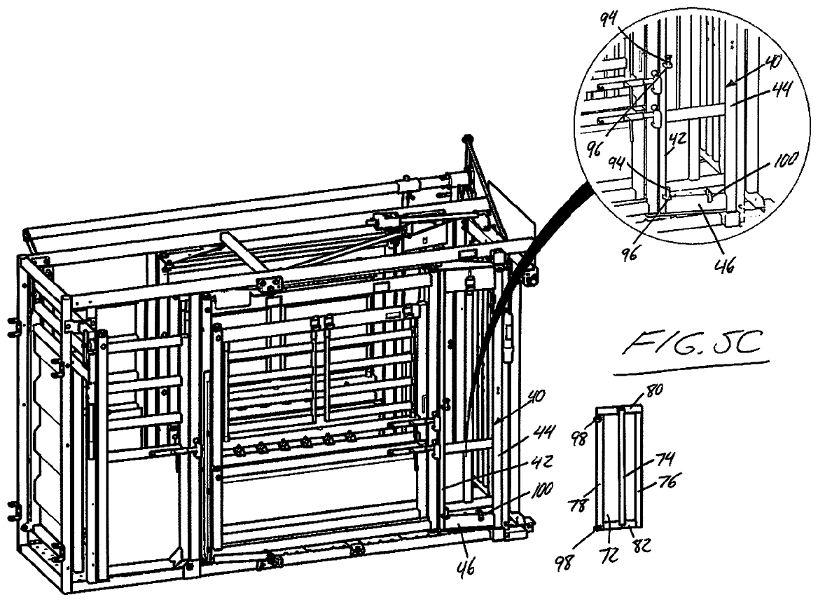

However, in other embodiments, the barrier member may be of alternative form and wider breadth, thus covering a greater portion, or even substantial entirety, of the upper area of the side-access opening 50. When withdrawn from the closed state standing upward from the lower side-gate 72 to fully open up the upper area of the side-access opening 50 for greater visual and physical access to an animal secured in the head gate 32, the barrier member 74 is manually swung downwardly out engagement from the top cross-member 48 of the gate frame 40. Swung open in this manner, the opened barrier member 74 is stowed in a position hanging downwardly along the exterior side of the lower side-gate 72 outside the chute, as shown in FIG. 5A, whereby no portion of the open barrier member remains elevated above the top end of the lower side-gate 72.

The lower side-gate 72 is hinged to the gate frame 40, for example at the rear frame member 42 thereof, to enable swinging horizontal movement between a closed position occupying, and thus obstructing, a substantial entirety of the lower area of the side-access opening 50, and an open position revealing the lower area of the side-access opening. This open position, together with the open state of the barrier member, enables full visual and physical access through the entire access opening to the animal secured in the head gate 32. The hinged connection between the lower side-gate 72 and the gate frame 40 in the illustrated embodiment is of a configuration that enables not only this pivotal movement between the open and closed positions, but also enables complete removal of the lower side-gate 72, and the attached upper barrier member 74, from the gate frame. This way, a worker-accommodating area outside the chute and adjacent to the gate frame 40 is not occupied at all by the open position of the side-gate 72, thus further improving the overall available working space at the side-access opening. The side-gate's hinged connection includes a pair of male stub shafts 94 standing upright in parallel and adjacent, but spaced, relation to the rear frame member 42 of the gate frame 40. Each stub shaft 94 stands upright from a larger-diameter stop 96 that is affixed to the rear frame member 42 at the outer side thereof opposite the chute interior. The hinged connection also includes a pair of protruding lugs 98 affixed to the exterior side of the rear side member 78 of the lower side-gate 72 thereof. Each such hinge lug 98 has an aperture penetrating vertically therethrough to form a female receptacle that rotatably receives a respective one of the male stub shafts 94.

The protruding lugs 98 reside respectively above the stops 96 of the two stub shafts 94. The lugs 98 normally rest on these stops 96, and thereby support the lower side-gate 72 at a normal default elevation residing closely adjacent to the bottom cross-member 46 of the gate frame 40. A gate stopper 100 is affixed to the bottom cross-member 46 in a position protruding upwardly therefrom so as to reach overlapping elevation with the lower cross-bar 82 of the side-gate's perimeter frame. This way, the gate stopper 100 blocks swinging of the lower side-gate 72 in either direction from its closed position whenever the gate is seated at its normal default elevation on the stops 96 of the stub shafts 94. Accordingly, the gate stopper 100 serves to normally lock the lower side-gate in its closed position in absence of a lifting action raising the lower-side gate out this normal default elevation.

Referring to FIGS. 5A and 5B, to open the lower side-gate 72, first the upper barrier member 74 must be lowered into its open state, as shown in FIG. 5A, after which the side-gate 72 is lifted up out of its normal seated position, for example through manual gripping of the top end of the gate or an attached lifting handle if provided (not shown). Once lifted to a first elevated state high enough to clear the gate stopper 100, or at least clear an outer portion of the gate stopper situated on the outside of the gate frame to specifically block outward swinging of the side-gate, but without lifting the hinge lugs 98 fully off the stub shafts 94, the gate is swung open outwardly, as shown in FIG. 5B, whereby this movement of the lower side-gate 72 and the attached upper barrier 74 reveals the lower area of the side-access opening 50 to enable visual and physical access to the animal therethrough. To remove the lower side-gate entirely, the lower side-gate 72 is lifted further up into a second elevation of greater height in order to lift the hinge lugs 98 fully off the stub shafts 94, thereby disconnecting the lower side-gate 72 from the gate frame 40, and enabling removal of the side-gate and hanging barrier member entirely from the squeeze chute, as shown in FIG. 5C.

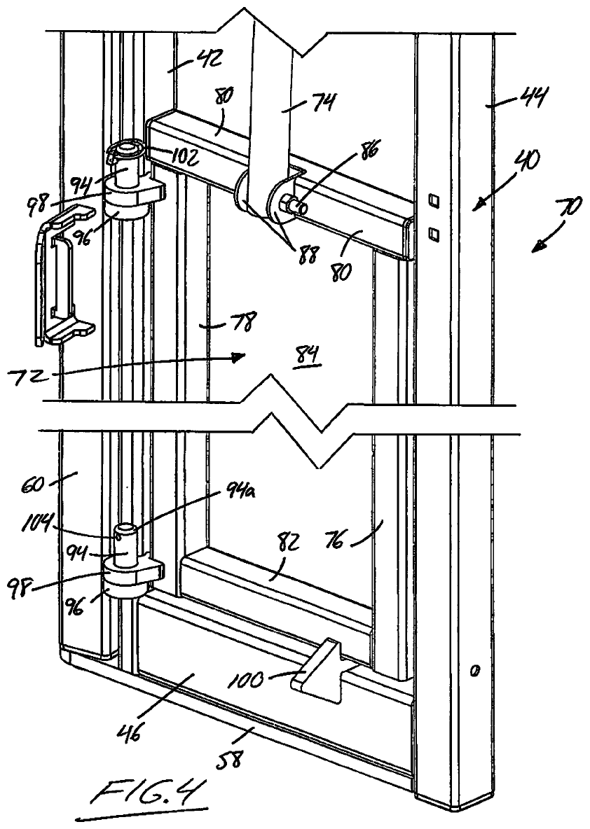

To prevent inadvertent removal of the lower side-gate 72 when attempting to merely open same, a respective lock pin 102 may be normally engaged in a cross-bore 104 of at least one of the stub shafts 94, as shown in FIG. 4, whereby removal of this lock pin 102 is required to fully lift and remove the lower side-gate 72 and attached upper barrier member 74. To enable easy re-mounting of the removed lower side-gate 72 back onto the gate frame, the stub shafts 94 of the illustrated embodiment deviate from a purely cylindrical form in order to provide an upward taper, at least at an uppermost region of the shaft. This tapered upper region 94a of each shaft reduces the amount of alignment accuracy needed to lower the lugs 98 down over the stub shafts during such re-mounting the door.

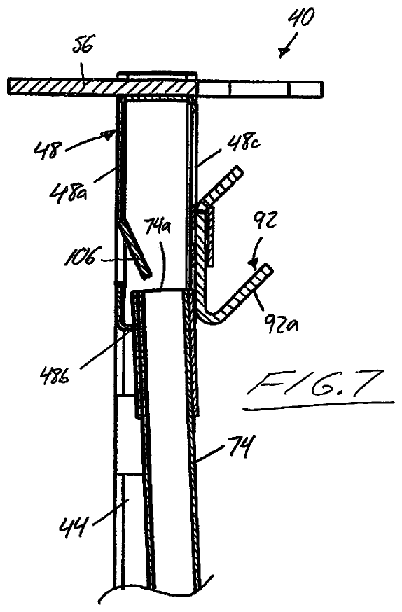

Referring to FIG. 7, which shows a cross-sectional view of the gate frame 40 at the top cross-member 48 thereof to illustrate receipt of the distal end 74a of the barrier member 74 therein, there is provided an additional stop feature 106 on the gate frame 40 that cooperates with the upper barrier member 74 to prevent the pivotally connected lower side-gate 72 from being lifted out of its normal elevation so long as the upper barrier member 74 is in its working position engaged with the top cross-member 48 of the gate frame 40. In the illustrated embodiment, this stop feature 106 is a stop tab that was cut and integrally bent from an inside wall 48a of a hollow-beam structure of the top cross-member 48. This stop tab 106 angles obliquely into the hollow interior of the top-cross member 48 so that the bottom end of this stop tab resides just above the distal end 74a of the upper barrier member when in its working position reaching into this interior space of the top cross member via cavity openings cut therein at bottom and outside walls 48b, 48c thereof. However, it will be appreciated that any component residing at a fixed location just above the distal end of the deployed barrier member may similarly serve as a stop feature, whether or not it is an integrally bent tab of the cross-member 48 itself. This stop feature 106, by blocking upward displacement of the upright barrier member 74, which is blocked from pivoting out of its working position by the catch 92 of the latch mechanism, thus prevents any lifting of the lower side-gate 72 until the upper barrier member 74 is swung down from its working position, subject to first lifting the catch 92 out the way to enable such pivotal movement of the upper barrier member.

It will be appreciated that while the illustrated embodiment places the stub shafts 94 in upright orientation atop stops 96 that are mounted to the gate frame, and places the cooperating lugs 98 on the side-gate 72, a reverse configuration may alternatively be employed in which the stops 96 are attached to the side-gate and have the stub shafts depending downward from the stops, with the lugs 98 instead being attached to the gate frame and the optional lock pin(s) 102 being engaged through the stub shaft(s) near the bottom end(s) thereof. Either way, the lugs and stops normally abut one another to hold the side-gate at its normal default elevation in which swinging movement is blocked by the gate stopper 100, while lifting of the side-gate to a first greater elevation enables opening of the side-gate, and further lifting of the side-gate to an even greater second elevation, with the lock pin removed, enables full removal of the side-gate. In either case, the stub shaft length is selected to exceed the height by which the gate stopper 100 overlaps with the normal default elevation of the side-gate so that lifting the side-gate to the first elevated state clearing the gate stopper 100 does not fully disengage the stub shafts from the female receptacles.

The disclosed side-gate assembly 70 provides more flexible options than the prior art in terms of partial or full height side access to an animal secured in the head gate 32 of the chute 10. A worker requiring only upper body access can simply unlatch and lower the pivotally mounted upper barrier member 74, without fear of loss or misplacement thereof since the upper barrier member 74 remains attached to the lower side-gate, even when moved to its open state withdrawn from the upper area of the side-access opening 50. Should access to the animal's lower body also be required, the user can partially lift the lower side-gate to its first elevated state, and swing the lower side-gate into its open position. Should this open position still be somewhat obstructive to the neighbouring working space outside the chute, the lower side-gate, and attached upper barrier member, can be removed entirely by lifting to the second elevated state, preferably subject to prior removal of a locking pin 102 that normally prevents inadvertent removal during the gate-opening process.

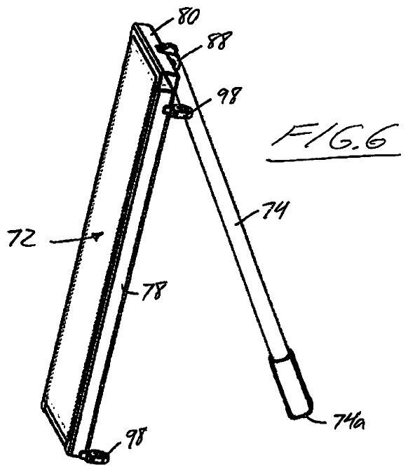

In addition to preventing loss or misplacement of the upper barrier members, the amalgamation of the lower side-gate and the upper barrier 74 into a pivotally coupled combination unit has another benefit, illustrated with particular reference to FIG. 6. Here, the barrier member 74 at an angled intermediate position part way between its working position standing upright from the lower-side gate, and its stowed position folded down against the side gate. In the intermediate position, the barrier member angles downwardly away from its pivotal connection to the side-gate at an oblique angle to the side gate, thus forming a prop by which the combination can be seated on the ground in a self-supporting state when removed from the gate frame. This limits ground contact of the gate/barrier combination to the bottommost edge of the side-gate, and the distal end of the barrier member 74, and thereby reducing accumulation of mud or dirt thereon, compared to laying of the removed side gate face-down on the ground. Likewise, the combined unit may be placed in the same self-supporting state with side-gate propped up by the barrier member regardless of whether the unit is stood as such atop the ground, or any other underlying support surface.

It will be appreciated that the novel inclusion of a movable upper barrier member, whether pivotably or otherwise movably supported on the openable/closeable lower side-gate, may be employed regardless of whether the openable/closeable lower side-gate is also removable, just as the novel use of a side-gate whose hinge assembly enables both swinging and full removal may be employed regardless of whether the side-gate is accompanied by an openable/closeable upper barrier member. If the barrier member is omitted, the side-gate may be of greater height than in the illustrated embodiment, for example being a full-height gate substantially occupying an entire height of the side-access opening 50. In embodiments where both the lower side-gate and upper barrier member are included, the relative height proportions of same may vary from that of the present invention where the top and bottom areas of the access opening respectively obstructed by these components are each approximately half of the overall area of the access opening. It will also be appreciated that though the illustrated embodiment uses a cladded side-gate for full-width occlusion of the side-access opening, a skeletal gate structure may alternatively be employed in other embodiments.

Since various modifications can be made in my invention as herein above described, and many apparently widely different embodiments of same made, it is intended that all matter contained in the accompanying specification shall be interpreted as illustrative only and not in a limiting sense.

1. In a livestock squeeze chute comprising a primary structural frame, a pair of movable side-walls situated on laterally opposing sides of an interior space of the squeeze chute through which animals traverse on a longitudinal pathway from an entrance opening at a first end of said squeeze chute to an exit opening at a longitudinally opposing end of said squeeze chute, and a head gate operably installed at said exit opening to enable securement of an animal at said exit opening, a side-gate assembly residing adjacent said exit opening in a space between a border frame of said exit opening and a respective one of the movable side walls, said side-gate assembly comprising:
a side-gate frame delimiting a side-access opening that communicates into the interior space of the squeeze chute from a surrounding environment external thereto for lateral access to an animal secured in the exit opening by the head gate;
an openable/closeable lower side-gate movably coupled to said side-gate frame in movable relation thereto between a closed position obstructing a lower area of said side-access opening, and an open position revealing said lower area of the side-access opening to enable access to the animal through said revealed lower area of the side-access opening; and
an upper barrier movably coupled to the lower side-gate in movable relation to the closed position thereof between a closed state at least partially obstructing an upper area of said side-access opening above the lower side-gate, and an open state withdrawn from said upper area of said side-access opening to enable greater access to the animal through said revealed upper area of the side-access opening.

2. The side-gate assembly of claim 1 wherein said upper barrier is pivotably coupled to the lower side-gate for pivotal movement relative thereto between the open and closed states.

3. The side-gate assembly of claim 1 wherein said upper barrier is configured to stand upright from said lower side-gate in the closed state, and to reside at an elevation not exceeding said lower side-gate in the open state.

4. The side-gate assembly of claim 1 wherein said upper barrier is configured to stand upright from a top end of said lower side-gate in the closed state, and to reside at an elevation not exceeding said top end of the gate in the open state.

5. The side-gate assembly of claim 1 wherein the upper barrier is pivotally coupled to the lower side-gate at or proximate a top end thereof.

6. The side-gate assembly of claim 5 wherein the upper barrier is pivotally pinned to the lower side-gate at an external side thereof.

7. The side-gate assembly of claim 1 wherein said upper barrier is configured to reside on an external side of the lower side-gate in the open state.

8. The side-gate assembly of claim 1 comprising a latch mechanism installed on the side-gate frame and configured to secure the upper barrier in the closed state.

9. The side-gate assembly of claim 8 wherein said latch mechanism is configured to automatically secure the upper barrier in the closed state upon movement thereof into said closed state.

10. The side-gate assembly of claim 7 wherein said latch mechanism is installed on a top cross-member of said side-gate frame.

11. The side-gate assembly of claim 7 wherein said latch mechanism is a slam latch mechanism biased into a locking condition and movable into a release condition by movement of the upper barrier into the closed state.

12. The side-gate assembly of claim 1 wherein said lower side-gate is a cladded gate obstructing a substantial entirety of said lower area of the side-access opening.

13. The side-gate assembly of claim 1 wherein said lower side-gate is removably coupled to the side-gate frame to enable select removal and installation of said lower side-gate to and from said side-gate frame.

14. The side-gate assembly of claim 13 wherein a hinged connection by which said lower side-gate is both pivotably and removably coupled to said side-gate frame comprises a set of male stub shafts and a cooperating set of female receptacles, which are distributed among said side-gate and said gate frame in co-operable relative positions to one another such said side-gate is pivotally movable between the open and closed positions while at a first elevation relative to the gate frame, and is removable from the gate frame by lifting of the side-gate to a greater second elevation at which the male stub shafts are disengaged from said female receptacles.

15. In a livestock squeeze chute comprising a primary structural frame, a pair of movable side-walls situated on laterally opposing sides of an interior space of the squeeze chute through which animals traverse on a longitudinal pathway from an entrance opening at a first end of said squeeze chute to an exit opening at a longitudinally opposing end of said squeeze chute, and a head gate operably installed at said exit opening to enable securement of an animal at said exit opening, a side-gate assembly residing adjacent said exit opening in a space between a border frame of said exit opening and a respective one of the movable side walls, said side-gate assembly comprising:
a side-gate frame delimiting a side-access opening that communicates into the interior space of the squeeze chute from a surrounding environment external thereto for lateral access to an animal secured in the exit opening by the head gate; and
an openable/closeable side-gate pivotally coupled to said side-gate frame for pivotal movement between a closed position obstructing at least a portion of said side-access opening, and an open position revealing said portion of the side-access opening to enable access to the animal through said revealed portion of the side-access opening;
wherein said side-gate is pivotably coupled, and also removably coupled, to said side-gate frame by a hinged connection that comprises a set of male stub shafts and a cooperating set of female receptacles, which are distributed among said side-gate and said gate frame in co-operable relative positions to one another such that said side-gate is pivotally movable between the open and closed positions while at a first elevation relative to the gate frame, and is removable from the gate frame by lifting of the side-gate to a greater second elevation at which the male stub shafts are disengaged from said female receptacles.

16. The side-gate assembly of claim 14 wherein said male stub shafts are supported on said side-gate frame and the female receptacles are carried on said side-gate.

17. The side-gate assembly of claim 14 wherein said female receptacles are defined in a set of protruding lugs.

18. The side-gate assembly of claim 17 wherein the stub shafts are supported by respective stops positioned for normal abutment thereof by said set of protruding lugs to support the side-gate on the gate frame.

19. The side-gate assembly of claim 14 further comprising a gate stopper positioned to block pivotal movement of the side-gate when at a default elevation relative to the gate frame, said default elevation being lesser than both of said first elevation at which said side-gate is pivotally movable, and said greater second elevation at which said side-gate is decoupled from the gate frame.

20. A method of using the side-gate assembly of claim 1 comprising, removing the lower side-gate and the upper barrier from the gate frame as a combined unit, thereby opening up both the upper and lower areas of the side-access opening, and placing the combined unit aside in a self-supporting condition in which the side gate is propped up from an underlying support surface by the upper barrier.

21. In a livestock squeeze chute comprising a primary structural frame, a pair of movable side-walls situated on laterally opposing sides of an interior space of the squeeze chute through which animals traverse on a longitudinal pathway from an entrance opening at a first end of said squeeze chute to an exit opening at a longitudinally opposing end of said squeeze chute, and a head gate operably installed at said exit opening to enable securement of an animal at said exit opening, a side-gate assembly residing adjacent said exit opening in a space between a border frame of said exit opening and a respective one of the movable side walls, said side-gate assembly comprising:
a side-gate frame delimiting a side-access opening that communicates into the interior space of the squeeze chute from a surrounding environment external thereto for lateral access to an animal secured in the exit opening by the head gate;
a lower side-gate configured for selective removable placement thereof in a closed position obstructing a lower area of said side-access opening;
an upper barrier configured for selective removable placement thereof in a working position standing upright from the closed position of the lower side-gate to at least partially obstruct an upper area of said side-access opening above said lower side-gate;
wherein the lower side-gate and the upper barrier are further configured for co-operable interaction in a self-supporting condition removed from said gate frame, with the upper barrier angling downward from said side-gate and thereby forming a supportive prop between said side-gate and an underlying support surface.

22. The side-gate assembly of claim 21 wherein said lower side-gate and said upper barrier are pivotally coupled together, and said upper barrier is pivotable between said working position standing upright from said lower side-gate, a stowed position hanging downwardly alongside said side-gate, and an intermediate position therebetween angling obliquely away from said side-gate to form said supportive prop.

23. A method of using the side-gate assembly of claim 21 comprising removing the lower side-gate and the upper barrier from the gate frame, and placing said lower side gate in said self-supporting condition on said underlying support surface.

24. The method of claim 23 comprising removing the lower side-gate and the upper barrier from the side-gate frame as a combined unit.

25. A livestock squeeze chute comprising the side-gate assembly of claim 1.

26. (canceled)
